(19) United States
(12) Patent Application Publication
(10) Pub. No.: US 2007/0164098 A1
(43) Pub. Date: Jul. 19, 2007

(54) Staging of Financial Accounts: The Ultimate Charge Account and Ultimate Credit/ATM Card

(75) Inventors: ATM Shafiqul Khalid, redmond, WA (US); Mahruma Khatoon Siddiqua, Redmond, WA (US)

Correspondence Address: ATM SHAFIGUL KHALID, 17446 NE 28TH ST., REDMOND, WA, 98052, US

(73) Assignee: ATM Shafiqul Khalid, Redmond, WA (US)

(21) Appl. No.: 11/306,055

(22) Filed: Dec. 15, 2005

Related U.S. Application Data
(60) Provisional application No. 60/639,258, filed on Dec. 28, 2004.

(51) Int. Cl. G06K 5/00; G06Q 40/00

(52) U.S. Cl. 235/380; 705/44

(57) ABSTRACT

This invention outlines a unique method and system where multiple accounts can be combined and user can access them from a single master account. Account holder or organization offering master account can define rule(s) maintained in a configurable table. Those rules dictate how a single transaction made to the master account can be executed using the combination of master account and child account(s). This technique enables a user to manage multiple accounts using a master account and an ATM/Debit/Credit card associated with the master account making universal card concept a reality. Such card is just like a regular card compatible with existing systems and usable wherever regular cards can be used without any added difficulties. This also disclose a technique to encode decode a sequence of transaction originated within a time segment to retrieve extra information that can be associated with the account.

### CROSS REFERENCE OF RELATED APPLICATION

This application claims priority from U.S. provisional patent application Ser. No 60/639,258 titled “Staging of financial account: the ultimate charge account and ultimate credit/ATM card” filed on the 28 of Dec. 2004.

### BACKGROUND

Consumers carry or manage multiple debit/credit cards or multiple financial accounts for various reasons. They don't have many options to carry just one or two cards or manage just one account while enjoying the benefit of having multiple accounts with higher credit limits and different benefits associated with those accounts. Carrying or managing less number of cards is always convenient. It is also secure and safe to carry less numbers of cards.

This had been a known problem for a long time. Few solutions were tried out without major success. For example smart card concept was very sound idea and most obvious one. Smart card can contain all the information from multiple cards into a single one and load unloads balance as needed. During transactions consumers can interact with the smart terminal and do whatever they want. The solution is technically very sound and feasible however they have major set backs. To implement those ideas current transaction system need to support the new methodology and new card system. It's difficult to upgrade all transaction systems all over the world at the same time keeping compatibility with the old system. Also merchant need to carry two different terminals or upgrade their current terminal to accept smart card that might not make much business sense unless majority people use smart card. And people don't use smart card much since most merchant doesn't use them. So the use of smart card was limited due to its deployment issue.

Current invention uses the existing infrastructure and at the same time offers the convenience of combining multiple cards into single card.

### The Proposed Method

The proposed invention offers a universal card system associated with a master account which is just like a regular account with added features backed by a reconfigurable policy table and a method to modify or split transaction and execute them as a 2^{nd} level of transaction on child account associated with the master account. The master account is associated with at least one other conventional account acting as a child account. Reconfigurable policy table contains rules that dictate how operations can be carried out on master or child account. A transaction processing system can transparently handle multiple other accounts associated with the master account on the background when a transaction is processed against the master account. Regular Credit can be issued against the master account. To consumer the card is no different that the regular card they used to carry. To any card accepting systems, the card is no different than other cards those card accepting systems used to process. Therefore the card is totally compatible with the existing infrastructure.

Processing transaction against master account might be multi-stage processing. The transaction processing system receives the transaction and makes a second stage of transactions using one or multiple accounts associated with the master account. Effectively it becomes multi-stage transaction processing. For example conventional over draft protection account automatically draw fund when primary account lacks of fund. The 2^{nd} level transaction transfer the fund from another account (may be line of credit or saving account) then 1^{st} level transaction draws the fund from the account. Here the automatic fund withdrawal from overdraft account can be considered as a static policy associated with the primary account. In this case the 2^{nd} account typically managed by the same organization managing the primary account and always it's a debit transaction.

In the proposed system the policy can be fixed or user defined. And the multiple account associated with the master accounts can be considered similar to overdraft account except the fact that those accounts can scattered all over the globe, might not be under direct control of the institute managing the master account, and transaction to those account can be tied up with some user defined policy or organization dictated policy. And type of transaction can be debit or credit transaction. And sometimes the system itself might originate transaction.

The configuration table contains rules needed to operate on the account. Sometimes organization can set rules to meet their business need. Their rules can be customer specific or organization specific. For example organization might set some policy like; account holder must use certain percentage of transaction solely for master account. Or if a customer default for certain period of time the organization will make transaction on child account. Customer can set the rule in configuration table to meet their need. They can set rule like “I want to use account C1 when amount exceed $500 dollar in single transaction” or when the merchant is Airlines “use account C2” etc. Or if a transaction doesn't fit in an account split it over multiple account.

The system will have an information table that will have all the information needed to manage the system. If an account needs to be attached to the master account, the table is updated with all the information so that transaction processor can make any transaction on the child account using the information in the table. If user needs to attach an ATM account with the master account, user will update the table with the pin information for the ATM account. Also the transaction processor that process transaction on master and child account can update the table to reflect current balance on different accounts. It might also update when a payment might be due on an account etc. This table might log transaction history that can be used to create new policy for the account holder.

A transaction processor received the transaction information on master account. The transaction can be credit or debit type and can be originated from any card processing terminal like POS ATM terminal, internal site etc. Sometimes the system itself can originate a transaction. The transaction will have all the information like who is making the transaction, for how much amount, etc. Then transaction processor look at the configuration table to see if there is any rule to dictate this transaction. Then it modifies the original transaction or breakup the original transaction to split over multiple child accounts as a 2^{nd} level transaction. When transaction processor makes the 2^{nd} level transaction on a child account, it act like a transaction processing terminal and post the transaction over the network child account was supposed to operate on. The issuer of the child account sees that transaction as a regular transaction and just executes it.

The transaction processor can make the 1^{st} level transaction on master account and complete that immediately and postpone 2^{nd} level transaction for a later processing whenever needed. Normally 2^{nd} level transaction might be costly so the organization might set some policy like if user doesn't pay the balance within 60 days or debit balance on master account exceed certain limit initiate 2^{nd} level of transaction.

User can specify some rule or policy as simple as like use Card C1 to do grocery, C2 for traveling purposes and C3 for any larger bill above $300. User can also specify how amount can be split across multiple accounts. Say if charge on Master account is $500+ split the amount between card C1 and C2 by 40% and 60%. Any combinations can be used. Again this policy can be as simple as use card C1 then card C2 then Card C3 etc. Individual can set policy that meets their own spending habits and benefit offered by different cards.

User can update the account information with some personal identification number (PIN) so that debit account D can be processed using the information when D is associated with the master account. When universal card U is used as a debit/ATM cards on an ATM terminal, user need to type PIN associated with U on the ATM terminal. Then ATM terminal processes the transaction on U using the PIN where U works as a normal ATM card. In the background while processing the transaction on U, the amount might come from multiple 2^{nd} level accounts associated with U.

Organization offering master account can add some credit limit to the account. They can offer a card attached to the master account. The card gives convenience to access the master account and eventually any account associated with the master account. The card can be a credit card/ATM card compatible with the existing infrastructure.

### BRIEF DESCRIPTION OF THE DRAWINGS

FIG. 1 is an Operational diagram how the proposed system works with existing infrastructure.

### DETAIL DESCRIPTION

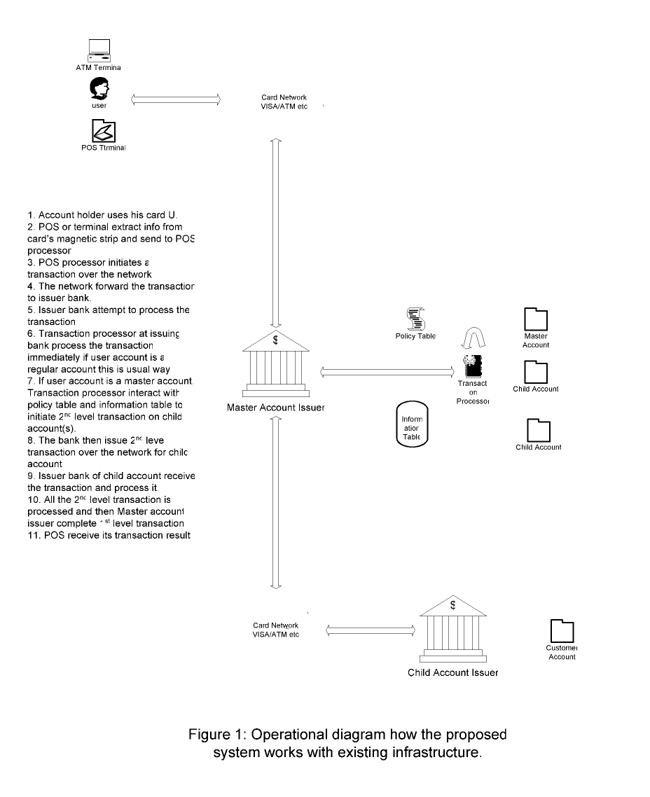

FIG. 1 outlines how the proposed solution works with the existing infrastructure.

In the figure Account holder use his card in POS ATM or in any terminal on a merchant site. The terminal extracts information from the magnetic strip and sent out to the processing center the terminal connected to. User can input card information in some other way as well like charging over internal that eventually routed to some processing center. Generally, Account holders name, account number, expiration date etc retrieved from the card and sent along with the transaction amount.

The processing center then issue a transaction over the network the card is supposed to work with. The network can be VISA ATM or other network. The network then route the transaction to the card issuer bank.

Card issuer bank has a means to execute the transaction that includes checking account balance, authorizing or declining the transaction etc. If the account is a regular account issuer bank immediately complete the transaction in available card.

If proposed system, if the card is issued against master account, transaction processor does more processing. It lookup configuration policy table to retrieve rules that match current transaction attributes like merchant, transaction amount, time of transaction etc. The processor then modifies the transaction or split the transaction over accounts based on the information in the information table. If more transaction needs to be done as a precondition to process the original transaction, the transaction processor then issue 2^{nd} level transaction on child account over the network child account supposed to work. Rules might say initiate 2^{nd} level transaction when debit balance on master account cross certain limit. Or rules might say if merchant is air lines initiate 2^{nd} level transaction on a specific child account. Any combination of rule is possible.

When transaction processor issue 2^{nd} level transaction on a child account over network, the network route that transaction to child account issuer bank. Child account issuer bank see the transaction as originated from a typical point of sales terminal and process that as a usual transaction. So the transaction between master issuer bank and child account issuer bank is compatible with existing structure. To make it efficient, those two banks can accumulate the transaction and settle between themselves privately.

When master account issuer bank get all the processing done it simply process the original transaction and send back to the originator, i.e., POS terminal where account holder used the card.

Transaction processor at master account keeps track of all transactions happening across master account and child account. Sometimes the processor might initiate transaction on itself for a child account based on the rules. User can set some rule like if Child account balance is outstanding for 20 days pays some dues immediately.

Let's take an example, John has 3 credit cards and one debit cards from 3 different financial organizations as follows:

C1 is a credit card offered by Institute X.

C2 is a credit card offered by Institute Y.

C3 is a credit card offered by Institute Z.

D is a debit card offered by Institute X

C1 card offer car insurance when a car is rented using the card.

C2 offer pretty good travel insurance if air ticket is purchased using the card.

C3 offer some great discount while John uses the card purchasing goods from a selected merchandise.

The universal card can be offered by any of the institute X, Y, Z simply by converting respective account into master account and giving John the option to associate rest of his cards. John can update the master accounts with all his cards, set policy how those cards should be used and just throw them away. Other organization can offer john universal card U with a new master account and John can simple associate all his credit card with the master account and just keep the universal card.

Say, X offer Universal Card U. They can simply offer john to make the account C1 as the master account where john can associate C2 and C3 with C1. Or X can offer a new card C4 associated with a new master account where John can associate C1 C2 and C3 with C4. Any organization capable of offering the type of card C1, C2, C3 or D can offer John the Universal Card as well.

In any case, once universal account is there for John, john need to attach his account/accounts (on his wish) to the master account. John also needs to update some policy how some transaction on the master account should be processed using associated accounts.

John can set up some rule/policy like:

When, “I charge the card on Air ticket divert my transaction on C2”

When, “I charge my card to rent a car divert my transaction on C1”

When, “I charge my card at Disney divert my transaction on C3”

Now, say john get a new universal card U form organization O, and John updates his policy accordingly. When he buy a ticket using card U from airlines, Airlines process the transaction on the card U as a regular card. The financial organization O managing U receive the transaction from airlines through the existing network may be Visa/MasterCard/Discover/American Express etc U was supposed to be supported by. Organization receives the transaction and while processing the transaction on the master account, it figures that John set some policy to divert airline transaction on Card C2. So O post the transaction to C2 using the network C2 was supposed to be supported by. So in reality, when John buy an airline ticket, C2 is used. When John rent a car using U, C1 will be used in reality.

John can associate his accounts with the master account and update policy as need basis just by calling an operator or using online interfaces. John can also change policy whenever needed. The organization O can also set policy as well mutually agreed between John and O to protect mutual interest.

Now to associate debit/ATM card D with U, U must be capable of using the ATM network. John needs to update account U with the Private Identification Number (PIN) for D so that when O receives an ATM withdrawal request against U, it can use D automatically using the PIN. John also need to create a pin for U as well. To withdraw cash from a ATM machine, john insert the Card U, then type his PIN number associated with U. ATM machine process the transaction on card U, however when the transaction is actually processed by organization O, it will be carried out using the policy agreed by John. A whole amount can be split across multiple accounts, posting can be delayed etc.

Organization O can offer great reward program offering some credit line to John. John can use that credit preserving rest of his credit for emergency. Organization O can set some rule like if payment is not made within certain period of time it can automatically withdraw fund from other accounts associated with the master account. In this case, credit line offered by O to John is less risky compare to open line of credit and hence O can offer John more rewards in terms of interest rate/money back/points mileage etc. So this can be win-win situation for both John and O.

There might be some draw backs using networks (Visa/MasterCard etc) more than once for a single transaction that might increase the transaction cost for a single transaction. However, over time, POS and organization offering Universal card can use private communication to carry out a transaction (may be over the internal using secure channel) minimizing transaction cost. In addition Organization O can partner with other financial organization to carry out 2^{nd} level transaction more smartly reducing transaction cost. User can use more credit offered by organization O so that less transaction needs multi stage transaction.

At the end user can carry a single card enjoying the benefit of keeping rest of his cards for emergency. And even user can enjoy more rewards.

Different way to Configure Policy and use the Invention

Extending policy:

This can add great value to consumers where they get great deal setting up policy to fit in their day to day needs. Here are few examples:

Sometime parent need to give their children ATM card or other card to do some shopping or children can have joint account with their parent, Children can over spend on the card or might try to charge the card in area parent doesn't like. Parents can set some policy for a particular day to carry out transaction differently that meets their need. Parents can set some policy how a card cane be used and where and when.

To reduce credit card fraud, consumers can strictly set policy not to spend over certain limit for security reason. Can restrict spending within geographical region, etc.

Consumer often forgets to pay minimum dues on account that cost more than 40 billion dollar to American consumers last year in terms of late fee. User can set some policy to trigger automatic payment on some child account from the master account based on some criteria.

Combining Universal card with Drivers license:

Since consumers need to carry just one universal card and consumer has the options to associate as many card as they want to the universal card, it would add great benefit to combine the universal card with drivers license. Driver's license carries pictures, signature, address that can make the card more secure and safe. Drivers license issuer (might be state agency), can get user's Universal card number and add credit card info so that POS can recognize that the license is in fact a valid card supported by the POS.

Coding Decoding of Sequence of Transaction

In existing network like VISA, MasterCard only support a transaction on an individual basis. If two transactions are posted on an account, they get executed separately. It might be harder to change the infrastructure over night for any extended functionality. Here we outline a unique technique that uses the existing network and at the same time extract more information can be associated with conventional card.

When a user slides a card through POS or ATM terminal or any entity serving as a processing terminal, the terminal contacts an outside authorization system requesting authorization for the transaction with the information extracted from the Card's magnetic strip along with the amount. It's also possible just to check if some amount can be changed on a card without charging the amount instantly to be posted at a later time. The authorization system route the request through supported network like Visa MasterCard depending on the card type. Then the network forwards the transaction information to Card issuer. The card issuer then executes the transaction and send the response over the network that eventually reach back to the originator terminal. So terminal can send some request for query balance or charge an amount against an account and receive some response that can be interpreted as YES/NO or account balance for the transaction.

A terminal will send a sequence of transaction against an account over the existing network within a fixed timeframe. The sequence is fixed for a particular type of information to retrieve. All those transaction are routed to card issuer. When the system responsible to process those transactions at the card issuer end see that there is a known pattern of transaction sequence it then process some transaction in the sequence in such a way so that the result can be reinterpreted at terminal end. The coding decoding protocol is known at both terminal end and processing end.

For example a terminal can issue authorization request (T1, T2, T3 . . . Tx, Ty, . . . , Tn) within a defined time window where x1, x2 . . . xn, are of different transaction. Each transaction can be in the form of query for a balance or attempt to charge something or any existing transaction type supported in the system. Say r1 ,r2, . . . rx . . . ry . . . rn is the usual response when those transaction are posted outside the sequence in different times not bounded by the time window. Now at the processing end, the transaction processor determines that the sequence has special meaning and executes few transactions in the sequence differently producing different result that it would do when processing the transaction as a stand alone. That is terminal end will receive r1 , r2 . . . Rx′ . . . Ry′ . . . Rn where Rx′ and Ry′ had been different response. The terminal can extract information from the whole response set.

Embedding Club card into Universal Card:

Here we will outline how above sequence coding technique can be used to validate club membership that can be associated with a card.

For example John is dining out at a restaurant that offer 15% discount for COSTO member. John has Costco membership and he associated his membership with his Universal card U so that he needs not to carry COSTCO card any more. The card issuer and COSTO have some mutual agreement to support membership validation. The restaurant's card charging terminal and the card issuer understand the sequence coding technique. So when John use his card at the restaurant's terminal the terminal issue a sequence of query kind of transaction something like 1.30, 1.51, 1.45, 1.06 if they can be transacted. When authorizing system responsible to handle transactions posted on U receive those sequence within a defined period of time, it interpret that the originating terminal is requesting if John has valid COSTCO membership. Transaction authorizing system contact COSTCO to check if john has valid membership there. If John has valid membership it can deny the last transaction which is not usual. The terminal will interpret that 1^{st} 3 transactions went OK and the only way 4^{th} one failed is John has membership in COSTCO. The protocol need to be well established.

Embedding Insurance Card info into Universal Card:

Health insurance card might have Group policy number or different number need to process an insurance claim. User need to update Say doctor's office has a card processing terminal that understands sequence coding. When a card is used in that terminal, the terminal simply send a sequence of transaction like (0.30 0.40 0.44 0.31 to be posted on the account. The transaction processor understands the sequence and authorizes 1^{st} three and decline 4^{th}. The terminal then understands the result of 4^{th} transaction as a sign that it can process the insurance query. Terminal then issue query for balance within a fixed time window. The transaction processor see the query request after the sequence and interpret that requester is trying to validate insurance info. The transaction processor the might contact insurance provider associated with the account and verify the info and send the query result as declined or some number like 10234.34 as a balance. The terminal then interprets the query result as the policy number 1023434. Insurance provider name group policy info or anything can be encoded decoded this way.

What is claimed is:

1. A system and method to manage multiple accounts using a master account comprising:
one account serving as a master account and at least one child account associated with the master account;
a configurable policy table setting rule or rules for operations to take place on said master account or child account(s); and
a means to execute a transaction directed to master account using the combination of master account and child account(s) in such a way so that rules set in said configurable policy table is not violated.

2. The method and system as recited in claim 1 further comprise a table that contains information related to master or child account(s).

3. Information as recited in claim 2 comprise any information needed to carry out transaction on said account(s).

4. Transaction as recited in claim 1 is debit or credit transaction.

5. Transaction recited in claim 1 is carried out in real time or is preserved to execute at a later time.

6. Master account or child Account(s) as recited in claim 1 can be backed by different organizations.

7. Transaction as recited in claim 1 is originated from card accepting point like POS(point of sales) ATM terminal, Internet site accepting Card or from another system and method as recited in claim 1.

8. A card is associated with the said master account as recited in claim 1.

9. A configurable policy table as recited in claim 1 contains rules that can be adjusted for individual organization offering master account or child accounts.

10. A configurable policy table as recited in claim 1 contains rules that can be adjusted for individual customer who owns the master accounts and child accounts.

11. A configurable policy table as recited in claim 1 is a static table with fixed policy where master and child account are backed by two different organizations.

12. Rules in the said configuration table as recited in claim 1 is constructed from the past transaction history in the accounts as recited in claim 1.

13. Child account as recited in claim 1 is managed by the said system and method as recited in claim 1 hereby giving a cascading form where child account in 1^{st} stage of transaction becomes a master account in 2^{nd} level of transaction.

14. A means to execute a transaction as recited in claim 1 comprising:
a step receiving a transaction T directed to master account and retrieves all the information associated with the transaction;
A method to Retrieve rules from the policy table that can be relevant to the transaction.

15. A means to execute a transaction as recited in claim 1 comprises a step to modify the original transaction into a new transaction with new target child account to comply with the rule in the policy table then execute the modified transaction as 2^{nd} level transaction to satisfy the original transaction.

16. A means to execute a transaction as recited in claim 1 comprises a step to break original transaction into smaller transactions to be transacted over master and child accounts as a 2^{nd} level transaction.

17. Smaller transactions as recited in claim 16 can be combined or grouped together or delayed to execute at a later time.

18. A means to execute a transaction as recited in claim 1 processes the 2^{nd} level transaction being an originator of the transaction and execute the transaction using the available network thereby acting as a transaction terminal and use existing network like VISA/Master card network to execute the transaction on the child account.

19. A means to execute a transaction as recited in claim 1 execute the 2^{nd} level transaction on a child account by reconfiguring rules in policy table or just by updating child account information.

20. A system and method to encode/decode sequence of transactions to retrieve information associated with a account comprising:
A method to interpret a sequence of Card transaction within a fixed time segment as a request for special information where special information is information not retrievable from any information associated with individual transaction in the sequence;
A means to execute at least one transaction in the sequence in a different way so that the originator of the sequence of transaction can interpret the sequence of transaction to get a reading on special information where a different way means it produce different result for the same transaction when executed outside the sequence.
